(19) United States
(12) Patent Application Publication
(10) Pub. No.: US 2002/0076585 A1
(43) Pub. Date: Jun. 20, 2002

(54) Operating method for direct methanol fuel cells

(76) Inventor: Konrad Mund, Uttenreuth (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/012,167

(22) Filed: Oct. 26, 2001

Related U.S. Application Data
(63) Continuation of application No. PCT/DE00/01162, filed on Apr. 13, 2000.

(30) Foreign Application Priority Data
Apr. 26, 1999 (DE) 199 18 885.8

(51) Int. Cl. H01M 8/00; H01M 8/04; H01M 8/18

(52) U.S. Cl. 429/17; 429/24; 429/21

(57) ABSTRACT

An operating method is described for cold-starting direct methanol fuel cells. After a load has been disconnected (during the preceding operating phase), air is removed from the cathodes by a residual anode gas, and hydrogen is generated at the cathodes by supplying electrical energy. The newly formed hydrogen is then stored. For starting-up, in a short-circuit mode, air is resupplied to the cathodes and hydrogen is supplied to the anodes. After an operating temperature has been reached, the operation is switched over to a methanol mode.

### CROSS-REFERENCE TO RELATED APPLICATION

This application is a continuation of copending International Application No. PCT/DE00/01162, filed Apr. 13, 2000, which designated the United States.

### BACKGROUND OF THE INVENTION

### FIELD OF THE INVENTION

The invention relates to a method for operating direct methanol fuel cells, i.e. for operating a stack or a unit containing fuel cells of this type.

Fuel cells enable energy from a chemical reaction, i.e. chemical energy, to be directly converted into electrical energy. To enable energy converters of this type to find widespread application, it is necessary to solve two significant problems, namely to reduce the costs of producing the units and the peripherals and of providing the fuel. Widespread technical use is expected to come primarily for fuel cells employed in electric traction, i.e. for mobile applications (see for example, the reference “Spektrum der Wissenschaft [Spectrum of Science]”, February 1999, pages A44 to A46).

The technology of proton exchange membrane or polymer electrolyte membrane (PEM) fuel cells has proven particularly suitable. This type of fuel cell, which preferably operates at temperatures of between 60 and 800° C., has hitherto been operated with hydrogen H₂ as the fuel (see for example the reference titled “Energie Spektrum [Energy Spectrum]”, vol. 13, No. 3/98, pages 26 to 29). Currently, however, half the rated power, which is based on an operating temperature of 60° C., is reached at room temperature. Until the problem of storing H₂ or a widespread network of refueling stations is solved, liquid fuels, such as gasoline and methanol, which are reformed into hydrogen-rich gas mixtures by a reformer, can be used as the fuel.

In this context, the concept of the direct methanol fuel cell (DMFC) is particularly advantageous. The fuel cell does not require a reformer, but rather the fuel methanol is converted directly at the anode of a PEM fuel cell.

However, this results in one difficulty. To achieve current densities of >0.1 A/cm² which are of interest at a technical level with a cell voltage of not less than 0.5 V, the operating temperature—with the anode catalysts which are currently available—must be ≧60° C. Therefore, one problem relates to the starting the direct methanol fuel cell which has remained in a load-free state for a prolonged period and the temperature of which has therefore fallen to room or ambient temperature. Therefore, experimental tests have proceeded in such a way that the cells are electrically heated externally.

A similar problem arises with PEM fuel cells that are operated with hydrogen and are at a temperature of, for example, approximately −20° C. In this case, the procedure is that at outside temperatures of less than 0° C. the cells remain under load. In this way, the heat of reaction which is generated remains in the system and ensures that the internal temperature does not drop below 0° C.

### SUMMARY OF THE INVENTION

It is accordingly an object of the invention to provide an operating method for direct methanol fuel cells which overcomes the above-mentioned disadvantages of the prior art methods of this general type, which allows the cells to be started even when they have not been operating for a prolonged period or the cell temperature has fallen below the operating temperature (cold start).

With the foregoing and other objects in view there is provided, in accordance with the invention, a method for operating direct methanol fuel cells. The method includes interrupting a supply of a gaseous oxidizing agent to the cathodes of the fuel cells after a load has been disconnected. The gaseous oxidizing agent present in the cathode chambers is removed using a residual anode gas. Electrical energy is fed to the fuel cells resulting in a generation of hydrogen and the hydrogen formed at the cathodes is stored. The supply of the electrical energy is then interrupted. The cathodes are resupplied with the gaseous oxidizing agent for start-up, and the hydrogen previously stored is fed to the anodes of the fuels cells. The fuels cells are operated in a short-circuit mode for heating up the fuel cells. Finally, the fuel cells are switched to a methanol mode, after an operating temperature has been reached, and the fuel cells are connected to the load. Air can be used as the gaseous oxidizing agent. One can use a battery or a capacitor for supplying the electrical energy. It is best to store the hydrogen under pressure and it is advantageous to change over to the methanol mode at a temperature ≧60° C.

Other features which are considered as characteristic for the invention are set forth in the appended claims.

Although the invention is described herein as embodied in an operating method for direct methanol fuel cells, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of the specific embodiment.

### DESCRIPTION OF THE PREFERRED EMBODIMENT

The basis for the solution to the problem on which the invention is based relates to the scenario in which the direct methanol fuel cell or a corresponding unit has been operated for a certain time, and therefore, the operating temperature has been reached. If no further power is then required, the fuel cell can be disconnected. Consequently, the temperature within the fuel cell or the unit falls to a temperature of less than 60° C., i.e. to a temperature at which the fuel cell or the unit can no longer be started of its own accord.

Therefore, the invention provides a procedure—after the load has been disconnected—which ensures that the fuel cell or the unit can easily be restarted. This requires a number of steps.

First, after the load has been disconnected, a supply of an oxidizing agent, which is preferably air, but may also be oxygen, to the cathodes is interrupted. Then, a gas mixture (i.e. a residual anode gas) that has formed on an anode side is briefly fed to the cathode chambers, so that the air that is still present in these chambers is flushed out. The residual anode gas that is formed by the anodic oxidation of methanol substantially contains carbon dioxide and water vapor, as well as (excess) methanol in vapor form.

When the air or oxygen has been removed from the cathode chambers, electrical energy is supplied to the cell or the unit, preferably from a battery or a capacitor. Then, in the process methanol is (continues to be) converted at the anodes, but no further oxygen is consumed at the cathodes, but rather hydrogen is generated. This is because the cathodic load and an absence of oxygen converts the protons that diffuse through the membrane and results in an oxidation of the methanol into a gaseous hydrogen, i.e. the hydrogen is separated out at the cathodes.

The hydrogen that is formed is stored in a tank. The hydrogen is preferably compressed, for example by a restrictor valve, and is then stored under pressure. When the hydrogen tank (gasometer) is full or contains sufficient hydrogen, the supply of current or energy to the unit is switched off. The unit can then cool to room or ambient temperature.

When the fuel cell unit is to deliver electrical energy again, a starting operation proceeds in such a way that the cathodes are supplied with oxygen, i.e. air or oxygen is fed to the cathode chambers. However, the anodes are not supplied with methanol, but rather, initially, with the stored hydrogen. For this reason, the unit is immediately able to start and provide electrical energy. The process makes use of the fact that the PEM fuel cell which is supplied with hydrogen is able to function, i.e. begins to operate, even at temperatures of around 0° C. In the process, it heats up, and since initially a short-circuit operation is used, as there is as yet no consumer connected, the energy from the hydrogen or the electrical energy which is generated can be completely converted into heat and used to heat up the unit.

After the operating temperature has been reached, preferably after a temperature of ≧60° C. is reached, operation is switched over to a methanol mode, i.e. the methanol that is used as the fuel is supplied to the anodes in the form of a methanol/water mixture. A load can then be applied to the unit, i.e. the unit can be connected to an external consumer. In a procedure of this type, it is necessary for the store for the hydrogen required for the starting operation to be dimensioned in such a way that the electrical energy generated during the short-circuit operation is sufficient to bring the fuel cell or the unit up to the temperature required for DMFC operation. However, this is easy to determine by suitable preliminary trials according to the particular application.

I claim:

1. A method for operating direct methanol fuel cells, which comprises the steps of:
interrupting a supply of a gaseous oxidizing agent to cathodes of the fuel cells after a load has been disconnected;
removing the gaseous oxidizing agent present in cathode chambers by use of a residual anode gas;
feeding electrical energy to the fuel cells resulting in a generation of hydrogen;
storing the hydrogen formed at the cathodes;
interrupting a supply of the electrical energy;
resupplying the cathodes with the gaseous oxidizing agent for start-up, and feeding the hydrogen previously stored to anodes of the fuels cells, and operating the fuels cells in a short-circuit mode for heating up the fuel cells; and
switching to a methanol mode, after an operating temperature has been reached, and connecting the fuel cells to the load.

2. The method according to claim 1, which comprises using air as the gaseous oxidizing agent.

3. The method according to claim 1, which comprises using one of a battery and a capacitor for supplying the electrical energy.

4. The method according to claim 1, which comprises storing the hydrogen under pressure.

5. The method according to claim 1, which comprises changing over to the methanol mode at a temperature >60° C.
